(19) United States
(12) Patent Application Publication
(10) Pub. No.: US 2023/0388972 A1
(43) Pub. Date: Nov. 30, 2023

(54) DISCONTINUOUS RECEPTION METHOD AND USER EQUIPMENT

(71) Applicant: Sharp Kabushiki Kaisha, Sakai City, Osaka (JP)

(72) Inventors: Ningjuan CHANG, Shanghai (CN); Renmao LIU, Shanghai (CN)

(21) Appl. No.: 18/032,583

(22) PCT Filed: Oct. 18, 2021
(86) PCT No.: PCT/CN2021/124351

§ 371 Date: Apr. 19, 2023

(30) Foreign Application Priority Data
Oct. 20, 2020 (CN) 202011128470.8

(51) Int. Cl. H04W 72/02; H04W 76/28; H04L 1/1829

(52) U.S. Cl. CPC H04W 72/02; H04W 76/28; H04L 1/1854

(57) ABSTRACT

Provided in the present disclosure are a discontinuous reception method and user equipment. The discontinuous reception method includes: user equipment (UE) receiving configuration information or scheduling information related to a multicast and broadcast service (MBS) service; the UE determining whether a discontinuous reception (DRX) configuration is configured in the configuration information or the scheduling information; and if no DRX configuration is configured in the configuration information or the scheduling information, the UE employing a DRX configuration corresponding to unicast for reception of the MBS service.

### TECHNICAL FIELD

The present disclosure relates to the technical field of wireless communications. More specifically, the present disclosure relates to a discontinuous reception method and corresponding user equipment.

### BACKGROUND

A new Radio Access Terminal (new RAT, NR) multicast and broadcast service (MB S) work item (see non-patent literature: RP-193248: New WID: NR Multicast and Broadcast Service) was approved in the 3rd Generation Partnership Project (3GPP) RAN #86 plenary session held in December 2019. One of the work objectives of the corresponding research project (see SP-190726) in SA2 (referred to as Objective A in SA2) is to enable MBS services to be supported in a 5G system (5GS), including public safety, V2X applications, IPTV, group communications, Internet of Things applications, etc. The objective of NR MBS work items in the RAN is to achieve the above objectives in SA2 so as to provide support or capabilities required in a radio access network (RAN). One of the specific work items therein is to define a corresponding transmission mechanism and scheduling mechanism for UEs in a radio resource control connected state RRC_CONNECTED, so that the UEs can receive broadcast/multicast services.

The present disclosure discusses relevant problems involved in achieving the above work objectives.

### SUMMARY

The objective of the embodiments of the present disclosure is to solve the problem of discontinuous reception in an RRC connected state for an MBS in an NR system. More specifically, the present disclosure presents a solution to the problem of how to achieve discontinuous reception on a unicast link when UE enters a radio resource control (RRC) connected state to perform reception for a high-reliability MBS service. The embodiments of the present disclosure provide a discontinuous reception method performed by user equipment and corresponding user equipment.

According to a first aspect of the present disclosure, provided is a discontinuous reception method, comprising: user equipment (UE) receiving configuration information or scheduling information related to a multicast and broadcast service (MBS) service; the UE determining whether a discontinuous reception (DRX) configuration is configured in the configuration information or the scheduling information; and if no DRX configuration is configured in the configuration information or the scheduling information, the UE employing a DRX configuration corresponding to unicast for reception of the MBS service.

In the discontinuous reception method according to the first aspect, the UE may employ the DRX configuration corresponding to unicast to monitor a PDCCH addressed via an MBS service identifier.

In the discontinuous reception method according to the first aspect, the MBS service identifier may be a group-radio network temporary identifier (G-RNTI), and the DRX configuration corresponding to unicast may be comprised in a MAC cell group configuration information element MAC-CellGroupConfig.

According to a second aspect of the present disclosure, provided is a discontinuous reception method, comprising: if user equipment (UE) receives a MAC PDU or a PDCCH addressed via a multicast and broadcast service (MBS) service identifier, and if the MBS service identifier is configured with uplink reception status feedback, a MAC entity of the UE entering an active time in a discontinuous reception (DRX) operation for unicast, and monitoring a PDCCH addressed via a UE-specific identifier.

In the discontinuous reception method according to the second aspect, the MBS service identifier may be a group-radio network temporary identifier (G-RNTI); the UE-specific identifier may be a cell-radio network temporary identifier (C-RNTI) or a CS-RNTI; the DRX operation corresponding to unicast may apply a DRX configuration comprised in a MAC cell group configuration information element MAC-CellGroupConfig.

In the discontinuous reception method according to the second aspect, if the MAC PDU or the PDCCH addressed via the MBS service identifier and received by the UE is not successfully decoded, the MAC entity of the UE considers itself to be in the active time.

In the discontinuous reception method according to the second aspect, if the UE receives the MAC PDU or the PDCCH addressed via the MBS service identifier, and if the MBS service identifier is configured with uplink reception status feedback, the MAC entity of the UE starts a drx-HARQ-RTT-TimerDL timer associated with a corresponding hybrid automatic repeat request (HARQ) process in the DRX operation for unicast.

In the discontinuous reception method according to the second aspect, after expiry of the drx-HARQ-RTT-TimerDL timer, the MAC entity of the UE may start a drxRetransmision-TimerDL timer associated with a corresponding HARQ process, and when the timer drxRetransmision-TimerDL is running, the UE considers itself to be in the active time.

In the discontinuous reception method according to the second aspect, if the UE receives the MAC PDU or the PDCCH addressed via the MBS service identifier, and if the MBS service identifier is configured with uplink reception status feedback, the MAC entity of the UE may start a timer T1 in the DRX operation for unicast, and when the timer T1 is running, the UE considers itself to be in the active time to monitor the PDCCH addressed via the UE-specific identifier.

According to a third aspect of the present disclosure, provided is user equipment, comprising: a processor; and a memory storing instructions, wherein the instructions, when run by the processor, perform the discontinuous reception method described herein.

### BRIEF DESCRIPTION OF THE DRAWINGS

In order to understand the present disclosure and advantages thereof more fully, reference will now be made to the following description made in conjunction with the accompanying drawings.

FIG. 1 is a schematic diagram showing retransmission processing based on different protocol stack architectures.

FIG. 2 is a flowchart showing processing of a discontinuous reception method according to Embodiment 1 of the present disclosure.

FIG. 3 shows a block diagram of user equipment (UE) according to the present disclosure.

In the drawings, identical or similar structures are all marked by identical or similar reference numerals.

### DETAILED DESCRIPTION

According to the following detailed description of exemplary embodiments of the present disclosure made in conjunction with the accompanying drawings, other aspects, advantages, and prominent features of the present disclosure will become apparent to those skilled in the art.

In the present disclosure, the terms “include” and “comprise” and derivatives thereof mean inclusion without limitation; the term “or” has an inclusive meaning and means “and/or”.

In the present specification, the following various embodiments for describing the principles of the present disclosure are merely illustrative, and should not be interpreted in any way as limiting the scope of the disclosure. The following description with reference to the accompanying drawings is used to facilitate full understanding of the exemplary embodiments of the present disclosure defined by the claims and equivalents thereof. The following description includes a variety of specific details to facilitate understanding, but these details should be considered merely exemplary. Therefore, those of ordinary skill in the art should recognize that various changes and modifications may be made to the embodiments described herein without departing from the scope and spirit of the present disclosure. In addition, the description of known functions and structures is omitted for clarity and simplicity. In addition, the same reference numerals are used for similar functions and operations throughout the accompanying drawings.

A plurality of embodiments according to the present disclosure are specifically described below by using a Long Term Evolution (LTE)/NR mobile communication system and subsequent evolved versions thereof as an exemplary application environment. However, it is to be noted that the present disclosure is not limited to the following embodiments, but may be applied to other wireless communications systems. In the present disclosure, unless otherwise specified, the concept of a cell and the concept of a base station or a radio access network are interchangeable. An LTE system may also refer to a 5G LTE system and a post-5G LTE system (such as an LTE system referred to as an eLTE system or an LTE system that can be connected to a 5G core network). In addition, the LTE can be replaced with an evolved universal terrestrial radio access (E-UTRA) or an evolved universal terrestrial radio access network (E-UTRAN). “Cancel”, “release”, “delete”, “flush”, and “clear” are interchangeable. “Execute”, “use”, and “apply” are interchangeable. “Configure” and “reconfigure” are interchangeable. “Link” and “connection” are interchangeable. “Monitor” and “detect” are interchangeable.

The prior art involved in the embodiments of the present disclosure will be briefly described below.

Multicast and Broadcast Service Single Cell-Point to Multipoint (SC-PTM) Transmission Mechanism in LTE and Discontinuous Reception (DRX) Thereof:

The LTE system has two major multimedia broadcast multicast service (MBMS) transmission modes: multimedia broadcast multicast service single frequency network (MBSFN) and single cell-point to multipoint (SC-PTM). In SC-PTM, the base station broadcasts, via system information and/or control signaling transmitted on a single cell multicast control channel (SC-MCCH), MBMS services supported thereby and scheduling information thereof, such as time-frequency domain resources, etc. By acquiring these MBMS reception configurations, the UE learns MBMS services to be carried out or being carried out in the cell and configuration information required to receive these services, and receives, on the basis of which services are of interest to the UE, the corresponding services of interest on a single cell multicast transport channel (SC-MTCH). If control information of an MBMS service has changed, or an MBS session is about to start or end, or transmission information thereof is about to change, then the base station may inform the UE via a change notification, such as an SC-MCCH information change notification transmitted via a physical downlink control channel (PDCCH), or an SC-PTM stop notification via a media access control control element (MAC CE) mode and the SC-MCCH information change notification transmitted via the PDCCH. For the MBMS, different services/sessions can be distinguished by using different identities. In LTE, a temporary mobile group identity (TMGI) is generally used to uniquely identify one MBMS service, and includes a PLMN identifier and a service identifier. The service identifier (serviceId) is used to uniquely represent one MBMS service in one PLMN. The session identifier (sessionId) is an optional MBMS session identifier, and is generally used together with a TMGI to identify transmission or retransmission of a particular MBMS session. When transmitted in a radio network, one MBMS service is associated with one group identifier for the radio network (Group-Radio Network Temporary Identifier, G-RNTI). In general, in a radio network, MBMS services are in one-to-one correspondence with G-RNTIs. A radio bearer for MBMS services in LTE is referred to as an MBMS point to multipoint radio bearer (MRB). The parameters corresponding to the MRB are preconfigured (predefined), that is, the parameters do not need to be acquired by the UE from the network side via signaling. When the UE determines reception of one MBMS service, the MRB is established according to predefined parameters, and a corresponding G-RNTI is used to receive MBMS data on the corresponding physical channel. In the SC-PTM mechanism, the above MRB refers to a single cell MRB (SC-MRB).

For each G-RNTI, the MAC entity is configured with a DRX functionality by the RRC layer to control the UE to monitor the PDCCH of the G-RNTI. The configuration and use of the DRX functionality are implemented regardless of the RRC state, that is, they are the same for the RRC idle state and the RRC connected state. DRX of different G-RNTIs is performed independently. RRC configures the following DRX parameters for each G-RNTI: a timer onDurationTimerSCPTM, and timers drx-InactivityTimerSCPTM, SCPTM-SchedulingCycle, and SCPTM-SchedulingOffset. When the timer onDurationTimerSCPTM or the timer drx-InactivityTimerSCPTM is running, the MAC entity considers itself to be in the active time, and the UE needs to monitor the PDCCH corresponding to the G-RNTI; otherwise, the UE does not need to monitor the PDCCH corresponding to the G-RNTI.

For a G-RNTI, if a subframe satisfies the following equation, the MAC entity starts the timer onDurationTimerSCPTM:

[(H-SFN*10240+SFN*10)+subframe number] modulo (SCPTM-SchedulingCycle)=SCPTM-SchedulingOffset, where H-SFN is a superframe number, SFN is a system frame number, modulo is a modulo operation, and SCPTM-SchedulingCycle and SCPTM-SchedulingOffset are respectively the above scheduling cycle and scheduling offset value configured by the RRC. When in the active time, the MAC entity monitors the PDCCH for each PDCCH subframe. If the PDCCH indicates a downlink transmission, the MAC entity starts or restarts the timer drx-InactivityTimerSCPTM.

Discontinuous Reception (DRX) Mechanism in RRC Connected State in NR System:

When the UE is in the RRC connected state, the MAC entity may be configured by the RRC layer with a DRX functionality for controlling the MAC entity to perform a PDCCH monitoring activity for UE identifiers including a cell-radio network temporary identifier (C-RNTI), a cancellation indication RNTI (CI-RNTI), a configured scheduling RNTI (CS-RNTI), an interruption RNTI (INT-RNTI), a slot format indication RNTI (SFI-RNTI), a semi-persistent CSI RNTI (SP-CSI-RNTI), a transmit power control-PUCCH-RNTI (TPC-PUCCH-RNTI), a transmit power control-physical uplink shared channel-RNTI (TPC-PUSCH-RNTI), a transmit power control-sounding reference symbols-RNTI (TPC-SRS-RNTI), and an availability indication-RNTI (AI-RNTI). It can be understood that DRX in the current NR system is a data transmission mode for unicast. If not otherwise specified, when DRX is configured, the MAC entity uses a DRX operation to monitor the PDCCH discontinuously for all activated serving cells.

Parameters configured by the RRC layer to control the DRX operation include:
drx-onDurationTimer: the duration at the beginning of a DRX cycle;
drx-SlotOffset: the delay time before the start of the timer drx-onDurationTimer;
drx-InactivityTimer: the duration after the PDCCH indicates a new uplink or downlink transmission;
drx-RetransmissionTimerDL: the maximum duration until a downlink retransmission is received, the timer is per each downlink hybrid automatic repeat request (HARQ) process, except for the broadcast process;
drx-RetransmissionTimerUL: the maximum duration until an uplink grant for uplink retransmission is received, the timer is per HARQ process;
drx-LongCycleStartOffset: the long DRX cycle and a DRX start offset value;
drx-ShortCycle: the short DRX cycle, this parameter being an optional configuration;
drx-ShortCycleTimer: the duration of the short DRX cycle, this parameter being an optional configuration;
drx-HARQ-RTT-TimerDL: the minimum duration before a downlink assignment for HARQ retransmission is received, this timer is per downlink HARQ process, except for the broadcast process; and
drx-HARQ-RTT-TimerUL: the minimum duration before an uplink grant for uplink HARQ retransmission is received, the timer is per HARQ process.

The RRC layer may divide serving cells of the UE into two DRX groups, and each DRX group is configured with a group of serving cells. Each DRX group has its own drx-onDurationTimer and drx-InactivityTimer configurations, and the other DRX parameter configurations are shared by the two DRX groups.

For serving cells in one DRX group, the active time thereof includes the time while: the timers drx-onDurationTimer and drx-InactivityTimer are running, drx-RetransmissionTimerDL or drx-RetransmissionTimerUL is running, ra-ContentionResolutionTimer or msgB-ResponseWindow for reception of a random access response or a message B in a random access procedure is running, and a scheduling request (SR) is transmitted on an uplink control channel (physical uplink control channel, PUCCH) and is in a pending state, etc.

For a DRX group, if the short DRX cycle is configured, the UE starts using the short DRX cycle after the UE has received a DRX command MAC control element or after the expiry of drx-InactivityTimer. After the short DRX cycle timer drx-ShortCycleTimer expires or a long DRX command MAC control element is received, the long DRX cycle is used. If the short DRX cycle is configured, then the MAC entity, when in a subframe satisfying the following equation, starts the timer drx-onDurationTimer after the offset of drx-slotOffset slots from the beginning of the subframe:

[(SFN*10)+subframe number] modulo (drx-ShortCycle)=drx-StartOffset. If the long DRX cycle is used, then the MAC entity, when in a subframe satisfying the following equation, starts the timer drx-onDurationTimer after the offset of drx-slotOffset slots from the beginning of the subframe:

[(SFN*10)+subframe number]modulo(drx−LongCycle)=drx−StartOffset.

For a DRX group, when the MAC entity receives a (long) DRX command MAC control element, the timers drx-onDurationTimer and drx-InactivityTimer are stopped. When in the active time, the MAC entity monitors the PDCCH on the serving cells in the DRX group. If a PDCCH indicating a downlink transmission is received, then in the first symbol after the end of the corresponding transmission carrying downlink HARQ feedback, the drx-HARQ-RTT-TimerDL timer for the corresponding HARQ process is started, and the drx-RetransmissionTimerDL timer for the corresponding HARQ process is stopped. If a PDCCH indicating an uplink transmission is received, then in the first symbol after the end of the first repetition of the corresponding physical uplink control channel (PUSCH) transmission, the drx-HARQ-RTT-TimerUL timer for the corresponding HARQ process is started, and the drx-RetransmissionTimerUL timer for the corresponding HARQ process is stopped. After the timer drx-HARQ-RTT-TimerDL expires, if data of the corresponding HARQ process was not successfully decoded, then the drx-RetransmissionTimerDL timer for the corresponding HARQ process is started in the first symbol after the expiry of drx-HARQ-RTT-TimerDL. After the timer drx-HARQ-RTT-TimerUL expires, the drx-RetransmissionTimerDL timer for the corresponding HARQ process is started in the first symbol after the expiry of drx-HARQ-RTT-TimerUL. When the PDCCH indicates a new uplink or downlink transmission, the timer drx-InactivityTimer is started or restarted in the first symbol after the end of the PDCCH reception.

Regarding the ongoing NR MBS work item, different from the MBMS mechanism in LTE, the reliability and grouping functionality of some MBS services are taken into consideration. On the one hand, the UE needs to enter a connected state to perform an MBS session access procedure, so as to be authenticated by the network side to activate reception of the service. On the other hand, some services need to use a transmission mechanism in a connected state, in order to ensure the service quality thereof. That is, from the perspective of RRC, different services have different RRC state requirements. For some MBS services that have no requirements on the UE state, the MBMS transmission mode, such as SC-PTM, in the legacy LTE may be employed. For the MBS services requiring the connected state, the UE needs to be connected to the network and enter the connected state before receiving the MBS services. After entering the RRC connected state, the UE may receive, via dedicated RRC signaling, corresponding MBS configurations, such as corresponding radio bearer configurations, feedback mechanisms such as channel state indication (CSI) or hybrid automatic repeat request (HARQ) configurations, a feedback-based retransmission service, etc. That is, MBS reception in the NR system is dependent on the RRC state. For MBS services (referred to as first-type services) that can be received in the RRC idle state or the RRC inactive state (RRC_INACTIVE), preferably, scheduling information thereof for configuring time-frequency domain resources or transmission information is provided via broadcast signaling, such as system information or a schedulingInfo information element on an MCCH channel. For MBS services (referred to as second-type services) that need to be received in the RRC connected state (RRC_CONNECTED), preferably, scheduling information thereof is provided via RRC dedicated signaling, or is dynamically scheduled via the PDCCH. MBS services that a UE in the RRC connected state is interested in receiving may include both first-type services and second-type services.

For reception of the first-type MBS services, it is generally considered that the point to multipoint (PTM) multicast or broadcast mode is employed, and for the second-type MBS services, current reception modes include the following:
reception mode 1: reception is performed via only a point to multipoint (PTM) channel;
reception mode 2: reception is performed via only a point to point (PTP) channel;
reception mode 3: independent reception is performed on two channels via PTM and PTP modes simultaneously; and
reception mode 4: reception is performed via PTM and PTP modes, but the PTP channel is only used as a retransmission channel.

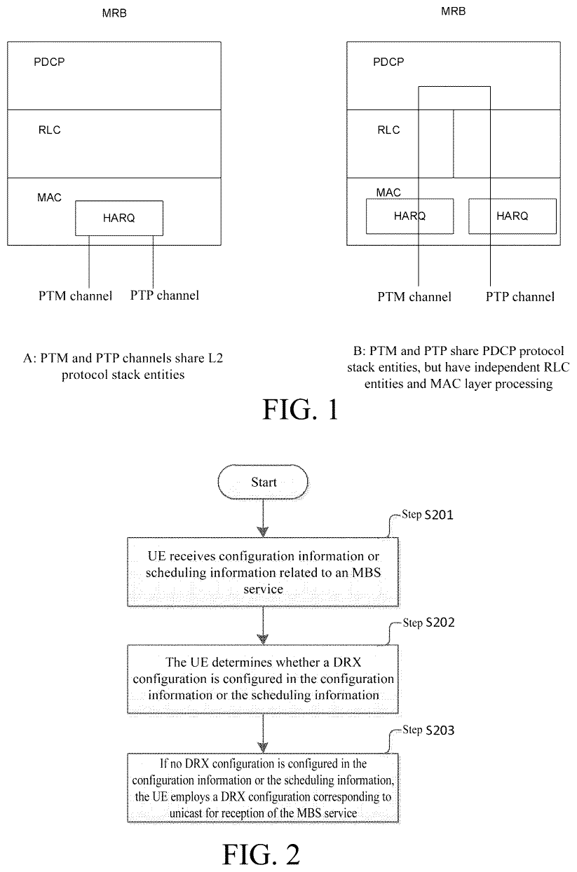

For the relationship between the PTM and PTP channels, the PTM and PTP channels may be radio bearers independent of each other, or may share some radio protocol layer entities (e.g., the packet data convergence protocol (PDCP) layer), but the other radio protocol layer entities are independent of each other. See FIG. 1 for details. In the present disclosure, reception on a PTP channel uses a UE-specific identifier, such as a C-RNTI, to perform addressing, and reception on a PTM channel uses a common identifier such as a G-RNTI. In reception mode 4, depending on different PTM and PTP protocol stack architectures, retransmission used on the PTP channel may be HARQ retransmission at the MAC layer, and in this case, initially transmitted data on the PTM channel and retransmitted data on the PTP channel may undergo HARQ combination at the MAC layer; alternatively, data packet retransmission, such as PDCP PDU-based retransmission, may be performed above the MAC layer, and in this case, the PTM and PTP channels are similar to the concept of split radio bearer in the NR system. However, the present disclosure is not limited to the above two modes.

In the LTE system, DRX for SC-PTM and DRX for unicast operate independently, that is, there is not interaction therebetween. However, in the NR system, currently only DRX for unicast is defined, and the DRX operation in the NR system described above is for unicast downlink data reception. If MBS reception may also be configured to be DRX in the NR system, in consideration of the above MBS reception mode 4 in the RRC connected state, a DRX configuration for MBS reception may include the following implementation modes:
Implementation mode 1: DRX for a unicast service and MBS DRX operate completely independently, and do not affect each other. This is similar to an operation mode between unicast DRX and SC-PTM DRX in LTE.
Implementation mode 2: DRX for a unicast service and MBS DRX use the same DRX functionality. That is, the DRX operation is performed without distinguishing between the unicast service and the MBS service. In this mode, MBS service reception and unicast service reception employ the same DRX operation and configuration.
Implementation mode 3: unicast DRX and MBS DRX are configured separately, and the DRX operations may affect each other.

In the present disclosure, the above MBS DRX refers to DRX corresponding to an MBS received via a PTM channel, and MBS reception performed via a PTP channel is considered to be a unicast DRX operation. On the basis of the above implementation modes for MBS reception, the present disclosure provides a solution to how to specifically implement functions of unicast DRX and MBS DRX. More specifically, for example, how to perform different DRX operations for MBS services of different reception types in implementation mode 2, and how to allow operations of unicast DRX and MBS DRX to interact with each other in implementation mode 3 are problems that the present disclosure focuses on.

On the basis of the above problems, a plurality of embodiments implemented on UE in the present disclosure are described as follows. Via the following embodiments, when UE uses reception mode 4 to perform MBS service reception, a corresponding DRX functionality can be applied to further reduce energy consumption of the UE.

### Embodiment 1

This embodiment provides a discontinuous reception method implemented on UE in an RRC connected state and based on implementation mode 2 of MBS DRX.

As previously described, MBS services that UE in the RRC connected state is interested in receiving may include both first-type services and second-type services. In DRX implementation in this embodiment, for the first-type service, a DRX configuration thereof and a corresponding operation are similar to the DRX configuration for SC-PTM and a corresponding operation in the existing LTE system, and the operation and an operation of DRX for unicast are independent of each other, and do not affect each other. For the second-type service, a DRX configuration and operation employed thereby are the same as those for DRX for unicast. That is, the DRX configuration and operation in the existing NR system are also applicable to data of the second-type service.

Preferably, scheduling information of each MBS service of first-type MBS services includes a corresponding PTM DRX configuration thereof (for example, including an on duration timer, the timer drx-InactivityTimer, a scheduling cycle SchedulingCycle or a scheduling offset SchedulingOffset in a schedulingInfo information element associated with an MBS service identifier), and because second-type MBS services use the same DRX configuration (DRX-config or drx-ConfigSecondaryGroup included in a MAC-CellGroupConfig information element) as an existing unicast service, scheduling information thereof does not include any corresponding DRX configuration. In this case, this embodiment can be expressed as: for an MBS service, if no DRX configuration is configured in configuration information or scheduling information thereof, then the UE employs a DRX configuration corresponding to unicast for reception of the MBS service. That is, the DRX configuration corresponding to unicast is employed in PDCCH monitoring addressed via an identifier corresponding to the MBS service, e.g., a G-RNTI.

Specifically, as an example, FIG. 2 is a flowchart showing processing of a discontinuous reception method according to Embodiment 1 of the present disclosure.

As shown in FIG. 2, in step S201, UE receives configuration information or scheduling information related to a multicast and broadcast service (MBS) service.

Then, in step S202, the UE determines whether a DRX configuration is configured in the received configuration information or scheduling information.

Then, in step S203, if it is determined in step S202 that no DRX configuration is configured in the configuration information or the scheduling information, the UE employs a DRX configuration corresponding to unicast for reception of the MBS service.

Alternatively, for each MBS service, the configuration thereof may include one piece of indication information. The indication information is used to indicate whether the DRX configuration corresponding to unicast is employed in PDCCH monitoring addressed via an identifier corresponding to the MBS service, e.g., a G-RNTI. Alternatively, the indication information may indicate whether the MBS service is a first-type service or a second-type service, and if the MBS service is a second-type service, the DRX configuration corresponding to unicast is employed in PDCCH monitoring addressed via an identifier corresponding to the MBS service, e.g., a G-RNTI.

For the above mode, in the DRX mechanism for unicast in the existing NR system (see section 5.7 of protocol specification 38.321), the MAC entity may be configured with a DRX functionality by an RRC entity to control the UE to perform a PDCCH monitoring activity for UE identifiers including a C-RNTI, a CI-RNTI, a CS-RNTI, an INT-RNTI, an SFI-RNTI, an SP-CSI-RNTI, a TPC-PUCCH-RNTI, a TPC-PUSCH-RNTI, a TPC-SRS-RNTI, and a G-RNTI. For PDCCH monitoring of the G-RNTI, the MAC entity only employs the configured DRX functionality when configuration information associated therewith is not configured with any PTM DRX configuration or the shown indication information.

### Embodiment 2

This embodiment provides a discontinuous reception method implemented on UE in an RRC connected state and based on implementation mode 3 of MBS DRX.

In this embodiment, similar to a DRX configuration mode of SC-PTM MBS reception and unicast reception in LTE, a DRX configuration corresponding to an MBS service received in a PTM mode and a DRX configuration corresponding to unicast are independent of each other in an NR system. In consideration of the reception mode in which a unicast PTP channel is used to receive an MBS service retransmission of a PTM channel, in this embodiment, a unicast DRX operation is performed according to the MBS service reception status of the PTM channel. If a MAC PDU or a PDCCH addressed via an MBS service identifier such as a G-RNTI is received, and if the G-RNTI is configured with uplink reception status feedback, a UE MAC entity enters an active time in a DRX operation for unicast, so as to monitor a PDCCH addressed via the C-RNTI (or the CS-RNTI) and corresponding to retransmission of MBS service data from the PTP channel. Preferably, when a received MAC PDU or PDCCH addressed via an MBS service identifier such as a G-RNTI is not successfully decoded, the UE MAC entity considers itself to be in the active time. Preferably, the G-RNTI being configured with MBS reception status feedback may also be described as feedback of a corresponding MBS service being enabled for the G-RNTI or the G-RNTI being configured with an associated uplink feedback transmission resource (e.g., a PUCCH configuration). The feedback may be HARQ feedback or L2 feedback (a radio link control (RLC) layer or PDCP state report).

### Embodiment 3

As previously described, in reception mode 4, depending on different PTM and PTP protocol stack architectures, the PTP retransmission may be retransmission based on different protocol layers. This embodiment provides a further method for Embodiment 2 on the basis of a protocol stack architecture (e.g., A in FIG. 1) in which the retransmission is HARQ retransmission at the MAC layer. If retransmission on a PTP channel is HARQ retransmission, initial transmission on a PTM channel and the HARQ retransmission on the PTP channel are performed in the same HARQ process, so that HARQ combination can be performed for an initially transmitted transport block received on the PTM channel and a retransmitted transport block received on the PTP channel.

If a MAC PDU or a PDCCH addressed via an MBS service identifier such as a G-RNTI is received, and if the G-RNTI is configured with uplink reception status feedback, the UE MAC entity starts a drx-HARQ-RTT-TimerDL timer associated with a corresponding HARQ process in the DRX operation for unicast. After the expiry of the drx-HARQ-RTT-TimerDL timer, the MAC entity starts a drxRetransmision-TimerDL timer associated with the corresponding HARQ process. Preferably, the MAC entity starts the drx-HARQ-RTT-TimerDL timer for the corresponding HARQ process in the first symbol after the end of the corresponding transmission carrying HARQ feedback. Preferably, the MAC entity starts a drx-RetransmissionTimerDL timer for the corresponding HARQ process in the first symbol after the expiry of the drx-HARQ-RTT-TimerDL timer. When the drxRetransmision-TimerDL timer is running, the UE considers itself to be in the active time, so as to monitor a PDCCH addressed via the G-RNTI, and corresponding to retransmission coming from the PTP channel and used to schedule MBS service data. Preferably, when a received MAC PDU or PDCCH addressed via an MBS service identifier such as a G-RNTI is not successfully decoded, the UE MAC entity starts the drxRetransmision-TimerDL timer associated with the corresponding HARQ process or the drxRetransmision-TimerDL timer. Preferably, the G-RNTI being configured with MBS reception status feedback may also be described as feedback of a corresponding MBS service being enabled for the G-RNTI or the G-RNTI being configured with an associated uplink feedback transmission resource (e.g., a PUCCH configuration). The being not successfully decoded may also be described as the UE feeding back NACK.

### Embodiment 4

As previously described, in reception mode 4, depending on different PTM and PTP protocol stack architectures, the PTP retransmission may be retransmission based on different protocol layers. This embodiment provides a further method for Embodiment 2 on the basis of a protocol stack architecture (e.g., B in FIG. 1) in which the retransmission is PDU retransmission at a protocol layer above the MAC layer. In this case, initial transmission on the PTM channel and packet retransmission on the PTP channel are not performed in the same HARQ process, so that combined decoding is not performed. For the initial transmission on the PTM channel, if decoding is not successful, the UE discards a received transport block directly.

If a MAC PDU or a PDCCH addressed via an MBS service identifier such as a G-RNTI is received, and if the G-RNTI is configured with uplink reception status feedback, the UE MAC entity starts a newly defined timer T in the DRX operation for unicast. When the timer T is running, the UE considers itself to be in the active time, so as to monitor a PDCCH addressed via the C-RNTI (or the CS-RNTI), and corresponding to retransmission coming from the PTP channel and used to schedule MBS service data. Preferably, when a received MAC PDU or PDCCH addressed via an MBS service identifier such as a G-RNTI is not successfully decoded, the UE MAC entity starts the timer T. Preferably, the G-RNTI being configured with MBS reception status feedback may also be described as feedback of a corresponding MBS service being enabled for the G-RNTI or the G-RNTI being configured with an associated uplink feedback transmission resource (e.g., a PUCCH configuration). The being not successfully decoded may also be described as the UE feeding back NACK.

Preferably, the MAC entity starts the timer T in the first symbol after the end of the corresponding transmission carrying HARQ feedback. Alternatively, the MAC entity starts the timer T after N symbols or milliseconds after the end of the corresponding transmission carrying HARQ feedback. N may be configured by a base station via RRC, or may be a fixed constant value.

In this embodiment, the timer T operates without distinguishing between HARQ processes. The value of the timer T may be configured by the base station via RRC.

### Embodiment 5

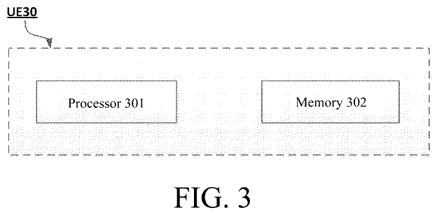

In this embodiment, user equipment according to the present disclosure is described. FIG. 3 shows a block diagram of user equipment (UE) according to the present invention. As shown in FIG. 3, user equipment (UE) 30 includes a processor 301 and a memory 302. The processor 301 may include, for example, a microprocessor, a microcontroller, an embedded processor, and the like. The memory 302 may include, for example, a volatile memory (such as a random access memory (RAM)), a hard disk drive (HDD), a non-volatile memory (such as a flash memory), or other memories. The memory 302 stores program instructions. When run by the processor 301, the instructions can perform the discontinuous reception method described in detail in the present invention.

In the present disclosure, some different embodiments can cooperate with each other. If not otherwise specified, concepts or definitions are applicable among the embodiments.

In the present disclosure, the term “base station” refers to a mobile communication data and control switching center with a larger transmit power and a wider coverage area, and has functions of resource distribution scheduling, data receiving and transmitting, and the like. The term “user equipment” refers to a user mobile terminal, for example, a terminal device capable of performing wireless communication with a base station or a micro base station, including a mobile phone, a notebook computer and the like.

The methods and related devices according to the present disclosure have been described above in conjunction with preferred embodiments. It should be understood by those skilled in the art that the methods shown above are only exemplary. The method according to the present disclosure is not limited to steps or sequences shown above. The base station and user equipment shown above may include more modules. For example, the base station and user equipment may further include modules that may be developed or will be developed in the future to be applied to a base station, an MME, or UE. Various identifiers shown above are only exemplary, not for limitation, and the present disclosure is not limited to specific information elements serving as examples of these identifiers. A person skilled in the art could make various alterations and modifications according to the teachings of the illustrated embodiments.

The program running on the device according to the present disclosure may be a program that enables a computer to implement the functions of the embodiments of the present disclosure by controlling a central processing unit (CPU). The program or information processed by the program may be temporarily stored in a volatile memory (for example, a random access memory (RAM)), a hard disk drive (HDD), a non-volatile memory (for example, a flash memory), or other memory systems.

The program for implementing the functions of the embodiments of the present disclosure may be recorded on a computer-readable recording medium. The corresponding functions may be achieved by reading programs recorded on the recording medium and executing them by the computer system. The phrase “computer system” herein may be a computer system embedded in the device, which may include operating systems or hardware (e.g., peripherals). The phrase “computer-readable recording medium” may refer to a semiconductor recording medium, an optical recording medium, a magnetic recording medium, a recording medium for programs that are dynamically stored for a short time, or any other recording medium readable by a computer.

Various features or functional modules of the device used in the above embodiments may be implemented or executed by circuits (for example, monolithic or multi-chip integrated circuits). Circuits designed to execute the functions described in this description may include general-purpose processors, digital signal processors (DSPs), application specific integrated circuits (ASICs), field programmable gate arrays (FPGAs) or other programmable logic devices, discrete gates or transistor logic, or discrete hardware components, or any combination of the above. The general-purpose processor may be a microprocessor, or may be any existing processor, controller, microcontroller, or state machine. The circuit may be a digital circuit or an analog circuit. When new integrated circuit technologies that replace existing integrated circuits emerge because of the advances in semiconductor technology, one or a plurality of embodiments of the present disclosure may also be implemented using these new integrated circuit technologies.

Furthermore, the present disclosure is not limited to the embodiments described above. Although various examples of the described embodiments have been described, the present disclosure is not limited thereto. Fixed or non-mobile electronic devices installed indoors or outdoors, such as AV equipment, kitchen equipment, cleaning equipment, air conditioners, office equipment, vending machines, and other household appliances, may be used as terminal devices or communications devices.

The embodiments of the present disclosure have been described in detail above with reference to the accompanying drawings. However, the specific structures are not limited to the above embodiments. The present disclosure also includes any design modifications that do not depart from the substance of the present disclosure. In addition, various modifications may be made to the present disclosure within the scope of the claims. Embodiments resulted from the appropriate combinations of the technical means disclosed in different embodiments are also included within the technical scope of the present disclosure. In addition, components with the same effect described in the above embodiments may be replaced with one another.

1-10. (canceled)

11: User equipment (UE), comprising a processor configured to:
receive a medium access control (MAC) packet data unit (PDU) or a physical downlink control channel (PDCCH) for a multicast broadcast service (MBS) identifier, which is a group-radio network temporary identifier (G-RNTI); and
if hybrid automatic repeat request (HARQ) feedback is enabled for the G-RNTI, start a timer drx-HARQ-RTT-TimerDL for a corresponding HARQ process in a first symbol after the end of the corresponding transmission carrying the HARQ feedback, wherein
the timer drx-HARQ-RTT-TimerDL defines a minimum duration before a downlink assignment for HARQ retransmission, and
the timer drx-HARQ-RTT-TimerDL is per downlink (DL) HARQ process except for the broadcast process.

12: A communication method for user equipment (UE), comprising:
receiving a medium access control (MAC) packet data unit (PDU) or a physical downlink control channel (PDCCH) for a multicast broadcast service (MBS) identifier, which is a group-radio network temporary identifier (G-RNTI); and
if hybrid automatic repeat request (HARQ) feedback is enabled for the G-RNTI, starting a timer drx-HARQ-RTT-TimerDL for a corresponding HARQ process in a first symbol after the end of the corresponding transmission carrying the HARQ feedback, wherein
the timer drx-HARQ-RTT-TimerDL defines a minimum duration before a downlink assignment for HARQ retransmission, and
the timer drx-HARQ-RTT-TimerDL is per downklink (DL) HARQ process except for the broadcast process.
